(19) United States
(12) Patent Application Publication
(10) Pub. No.: US 2020/0219149 A1
(43) Pub. Date: Jul. 9, 2020

(54) VALIDATING AND CONTROLLING SOCIAL POSTS

(71) Applicant: International Business Machines Corporation, Armonk, NY (US)

(72) Inventors: Peter Edward STUBBS, Georgetown, MA (US); Raghuveer Prasad NAGAR, Kota (IN)

(21) Appl. No.: 16/243,077

(22) Filed: Jan. 9, 2019

(51) Int. Cl. G06Q 30/02; G06Q 50/00

(52) U.S. Cl. CPC G06Q 30/0282; G06Q 50/01

(57) ABSTRACT

Embodiments generally relate to validating and controlling social posts. In some embodiments, a method includes receiving, at a social network, a post created by a user. The method further includes determining that the post contains negative sentiments. The method further includes determining that the post is about a business that has subscribed to a post tracking service. The method further includes determining asserted information in the post. The method further includes searching known information that is relevant to the asserted information. The method further includes matching the asserted information against the known information. The method further includes validating the post based at least in part on the matching of the asserted information against the known information. The method further includes disabling an ability of users of the social network to distribute the post if the post is not validated.

### BACKGROUND

Many retail customers are also active on social networks. Social networks provide sharing features that enable users to make and share social posts with others in social networks. Such social posts may include text, photos, images, audio, etc. Many social posts go viral on the Internet in that they spread rapidly to many users (e.g., thousands up to millions of users) in social networks, which can be beneficial to the retailer if the social post is positive or detrimental if the social post is negative.

### SUMMARY

Disclosed herein is a method for validating and controlling social posts, and system and a computer program product as specified in the independent claims. Embodiments are given in the dependent claims. Embodiments can be freely combined with each other if they are not mutually exclusive.

In an embodiment, a method includes receiving, at a social network, a post created by a user. The method further includes determining that the post contains negative sentiments. The method further includes determining that the post is about a business that has subscribed to a post tracking service. The method further includes determining asserted information in the post. The method further includes searching known information that is relevant to the asserted information. The method further includes matching the asserted information against the known information. The method further includes validating the post based at least in part on the matching of the asserted information against the known information. The method further includes disabling an ability of users of the social network to virally distribute the post if the post is not validated.

In another embodiment, to validate the post, the method further includes verifying if the user is a customer of the business. In another aspect, to validate the post, the method further includes: determining if the post refers to a product purchased from the business; and verifying if the user purchased the product from the business. In another aspect, to validate the post, the method further includes: determining if the post refers to a product purchased from the business; determining if the post includes media associated with the product; and verifying the media based on one or more media validation criteria. In another aspect, to validate the post, the method further includes: generating a query; and sending the query to the user who created the post, where the query requests verifying information. In another aspect, to disable the ability of users of the social network to virally distribute the post, the method further includes preventing users from marking the posting with a “like” or “share” feature. In another aspect, the method further includes enabling the ability of users of the social network to virally distribute the posting if the post is validated.

### BRIEF DESCRIPTION OF THE DRAWINGS

FIG. 1 is a block diagram of an example environment for validating and controlling social posts, which may be used for embodiments described herein.

FIGS. 2 and 3 illustrate an example flow diagram for validating and controlling social posts, according to some embodiments.

FIGS. 4 and 5 illustrate an example flow diagram for validating a social post, according to some embodiments.

FIG. 6 is a block diagram of an example computer system, which may be used for embodiments described herein.

### DETAILED DESCRIPTION

Embodiments described herein validate and control social posts. Embodiments validate and control social posts for retails in order to detect fraudulent social posts and to prevent such fraudulent social posts from being distributed to others and spreading virally (circulating rapidly on the Internet).

Embodiments relate to a customer publishing a post on a social network, where the post describes a negative experience that the customer had with particular a business. Social networks provide features that allow the sharing of a social post with others. Hereinafter, the term “social post” may be used interchangeably with the term “post.” A negative post about a business can damage the reputation of the business. Often, a post about a business can be fraudulent (not truthful). For example, the customer may not have actually purchased the item about which they are posting, or may not even be an actual customer. As described in more detail herein, embodiments protect a business by detecting and preventing fraudulent posts from going viral.

In some embodiments, a system receives, at a social network, a post created by a user. The system determines whether the post contains negative sentiments, and also determines whether the post is about a business that has subscribed to a post tracking service. The system then validates the post based on one or more predetermined post validation criteria. For example, a post validation criteria may include deeming a post validated if the user is an actual customer of the business, or deeming a post fraudulent if the user is not an actual customer of the business. In another example, a post validation criteria may include deeming a post validated if the user purchased the product (mentioned in the post) from the business, or deeming a post fraudulent if the user did not purchase the product from the business. In various embodiments, the system disables the ability of users of the social network to virally distribute the post if the post is not validated/is fraudulent.

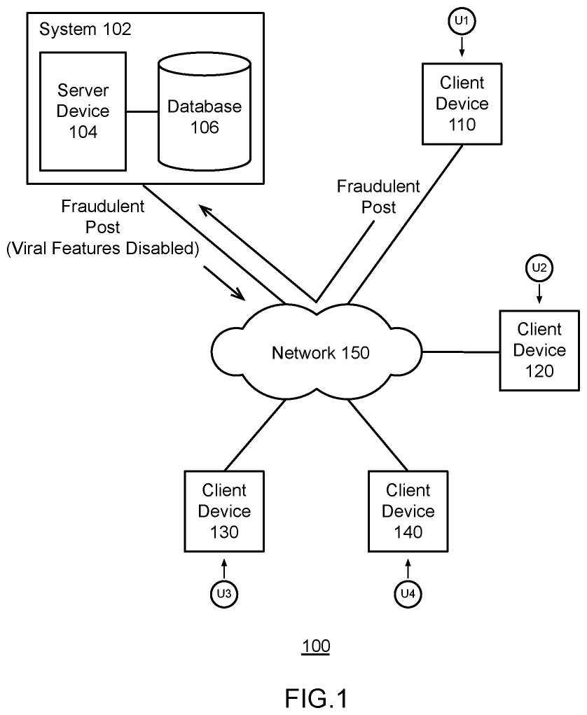

FIG. 1 is a block diagram of an example environment 100 for validating and controlling social posts, which may be used for some implementations described herein. In some implementations, environment 100 includes a system 102, which includes a server device 104 and a database 106. Environment 100 also includes client devices 110, 120, 130, and 140, which may communicate with system 102 and/or may communicate with each other directly or via system 102. Environment 100 also includes a network 150 through which system 102 and client devices 110, 120, 130, and 140 communicate. Network 150 may be any suitable communication network such as the Internet or combination of networks, etc.

As indicated herein, many retailer customers are active on social networks, where customers share posts in social networks. As shown, user U1 is attempting to publish a post to a social network, which is provided by system 102. As described in more detail herein, system 102 validates the post to determine if the post is valid (truthful) or fraudulent (not truthful). In this particular example the post includes fraudulent content such as text, media (e.g., images, videos), etc. As described in more detail herein, if the system detects a fraudulent post, the system prevents the fraudulent social post from being distributed to other users and spreading virally. For example, the system may disable viral features than enable a post to go viral (e.g., spread rapidly to other others such as users U2, U3, U4, etc.).

In various embodiments, the system provides users with features such as “share” features, “like” features, etc. A “share” feature may allow a user to publish a post on a public page or wall, or may allow a user to send a post to multiple other users simultaneously. In some embodiments, a “share” feature for a given post may be extended to any user who views the post. A “like” feature may allow a user to indicate that the user likes or approves a particular post by clicking on a “like” button. The “like” button may be labeled with “like” text, a thumbs up, etc. In some embodiments, the “like” feature causes a “liked” post to automatically be shared with users associated with each user who “likes” a post. These features may be referred to as like viral features in that they enable a post to be spread virally on the Internet, including social networks. By disabling such viral features, the system effectively prevents a given post from being distributed and from spreading virally. Further embodiments directed to the validation and control of posts are described in more detail herein.

For ease of illustration, FIG. 1 shows one block for each of system 102, server device 104, and database 106, and shows four blocks for client devices 110, 120, 130, and 140. Blocks 102, 104, and 106 may represent multiple systems, server devices, and databases. Also, there may be any number of client devices. In other implementations, environment 100 may not have all of the components shown and/or may have other elements including other types of elements instead of, or in addition to, those shown herein.

While server 104 of system 102 performs embodiments described herein, in other embodiments, any suitable component or combination of components associated with server 102 or any suitable processor or processors associated with server 102 may facilitate performing the embodiments described herein.

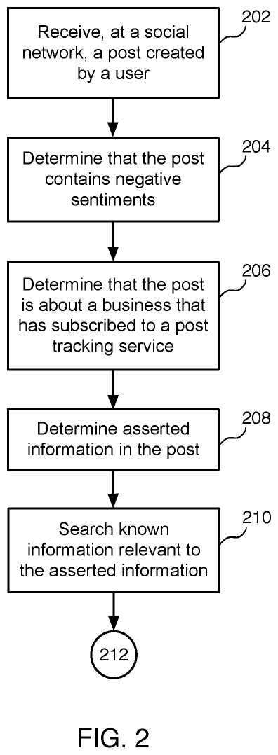

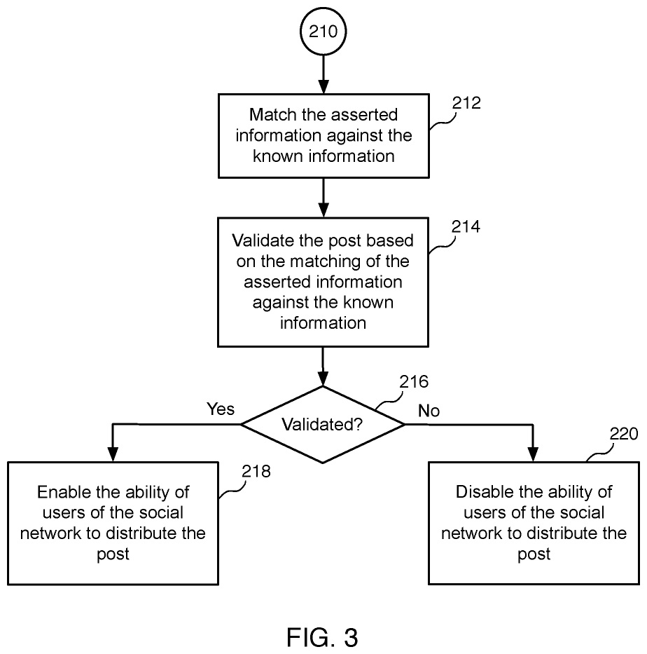

FIGS. 2 and 3 illustrate an example flow diagram for validating and controlling social posts, according to some embodiments. As described in more detail herein, the system validates and controls social posts for retailers by detecting fraudulent social posts and preventing such fraudulent social posts from spreading virally (circulating rapidly over the Internet). Such posts are fraudulent in that they contain asserted facts that are untruthful. Untruthful information is misleading due to false statements, doctored images, etc. As such, the system helps retailers in preserving their brand and reputation.

Referring to both FIGS. 1 and 2, a method begins at block 202, where a system such as system 102 receives, at a social network, a post created by a user. In various embodiments, system 102 may provide one or more social network platforms for users to share posts. In some embodiments, system 102 may be integrated with one or more social network platform for users to share posts, where system 102 has access to and control over posts.

At block 204, the system determines that the post contains negative sentiments. When a user selects the option to publish/make a post, and before the post is published, the system uses cognitive techniques involving cognition tools including sentiment analysis to detect if the post can lead to a negative impression of the retailer.

In various embodiments, sentiment analysis, also referred to as opinion mining, may employ cognitive analysis techniques to identify negative sentiment in posts. In various embodiments, to implement various blocks of the flow diagrams of FIGS. 2 to 5, the system may employ various cognitive analysis techniques such as text analysis, natural language processing, computational linguistics, etc., in order to identify various information (e.g., user identity, product identity, other information, photos, etc.). For example, in various embodiments, the system may use image recognition techniques for photos and videos, where the system detects images indicating negative sentiment (e.g., insects in food products, etc.).

At block 206, the system determines that the post is about a business that has subscribed to a post tracking service. For example, various businesses may subscribe to a post tracking service that is provided by the system in association with one or more social networks. In some embodiments, the system identifies a product that is referenced in the post. The system then searches a business database to find a business that is associated with the product. In some embodiments, the business database may be located in database 106 of FIG. 1 or in another database accessible by the system). The system then determines if there is a match between the product and a business in the business database. If there is a match, the system then determines from information in the business database whether the business has subscribed to the post tracking service. In various embodiments, if the business is subscribed to the post tracking service, the system prevents fraudulent posts from going viral by verifying negative posts that are made about that business, which is described in more detail below.

At block 208, the system determines asserted information in the post. For example, the system may determine user-identifying information (e.g., name, user identifier, email address, etc.), product-identifying information (e.g., product name, make name, model name, model number, etc.), media items (e.g., photos, videos, etc.), asserted facts (e.g., insect, expiration date, etc.), etc.

At block 210, the system searches known information that is relevant to the asserted information. For example, if the system recognizes user-identifying information, the system may search one or more corpora of user information in one or more associated databases. Similarly, if the system recognizes product-identifying information, the system may search one or more corpora of product information in one or more associated databases. If the system recognizes media items (e.g., attached photos, videos, etc.), the system may search one or more corpora of media items and associated information in one or more associated databases. In various embodiments, such corpora of known information may reside at the system (e.g., database 106 of FIG. 1, etc.), at the business that is relevant to the post, and/or at any other suitable datastore.

Referring to FIGS. 1, 2, and 3, at block 212, the system matches the asserted information against the known information. In various embodiments, the system may match asserted information against the known information using various cognitive analysis techniques described herein.

At block 214, the system validates the post based at least in part on the matching of the asserted information against the known information. For example, the system may use a cognitive model to determine if matches are found between the asserted information and the known information. In some embodiments, the system may derive additional information for verification to be requested from the user, and requests the same. If the user provides the requested particular information (e.g., order date, etc.), the system verifies the user-provided information. If not, the system may factor in the lack of a response and/or the missing information in the final decision as to whether the post is valid or fraudulent.

In some embodiments, particular matches between the asserted information and the known information indicate that the asserted information is true. In some implementations, the system may deem known information that corroborates with the asserted information as a match. For example, the post may show Bob Smith as the user and a grape drink as the product. The system might instead find Robert Smith in a customer database and that Robert Smith purchased a white grape drink. While not an exact match, the known information corroborates with the asserted information. As such, the system validates the asserted information and the post itself.

In some embodiments, discrepancies or contradictions between the asserted information and the known information indicate that the asserted information is untrue or untruthful. For example, the post may mention that a drink was purchased 1 month after the expiration date, but the system determines from the purchase history and inventory datastore that the purchase was made before the expiration date. As such, the system does not validate the asserted information or the post, and deems the post as fraudulent.

In various embodiments, the system validates the post based on one or more predetermined post validation criteria. In various embodiments, the system validates the post by analyzing the contents of the post and verifying the specific contents of the post based on one or more validation criteria. In various embodiments, the contents of the post may include a user who made the post, a reference to a product, a rating or comment about the product and/or business, one or more media items, purchase information, etc.

As described in more detail below, the system may validate that the user publishing the post is an actual customer of the business. The system may also validate that the user actually bought the product from the business. The system may also validate media items and other information contained with the post.

In various embodiments, the system may use various cognitive tools including advanced image search and recognition techniques to validate information in the post against information provided by the business or retailer. Such information to be compared may include metadata (e.g., history information including purchase date, purchase location, images, etc.). In some embodiments, the system may factor in secondary validation information from the business in order to validate a post. For example, the system may prompt the user for supplemental purchase information that the system might not have available (e.g., purchase date, expiration dates, etc.). In some embodiments, the retailer may provide corroborating or contradictory information in response to information provided in the post in question. Various example embodiments directed to validation of posts are described in more detail below.

At block 216, the system determines if the post is validated. If yes, the flow continues to block 218. If no, the flow continues to block 220.

At block 218, the system enables the ability of users of the social network to distribute the post if the post is validated. For example, if it is determined that the post is valid, the system allows the user to publish the post and allows other users to share and like the post.

At block 220, the system disables the ability of users of the social network to virally distribute the post if the post is not validated (fraudulent). For example, in some embodiments, the system may disable particular post options such as “share” capabilities and/or “like” capabilities, which can make a post go viral. As a result, the system prevents fraudulent posts from going viral in a timely and preventive manner.

In the following example scenarios, customers are frustrated with a business and attempt to publish negative posts about the business on a social network. Unfortunately, to harm the business, the customers/users are attempting to publish posts with fraudulent information. As indicated above, fraudulent posts are considered fraudulent in that they contain asserted facts that are untruthful. Such untruthful information is misleading due to false statements, doctored images, etc. Such fraudulent posts could be distributed to other users and may possibly spread virally (circulate rapidly on the Internet).

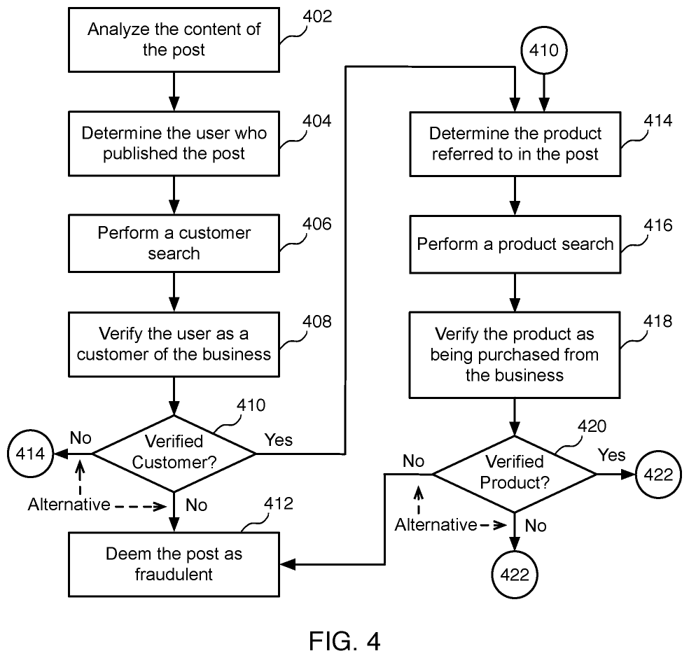

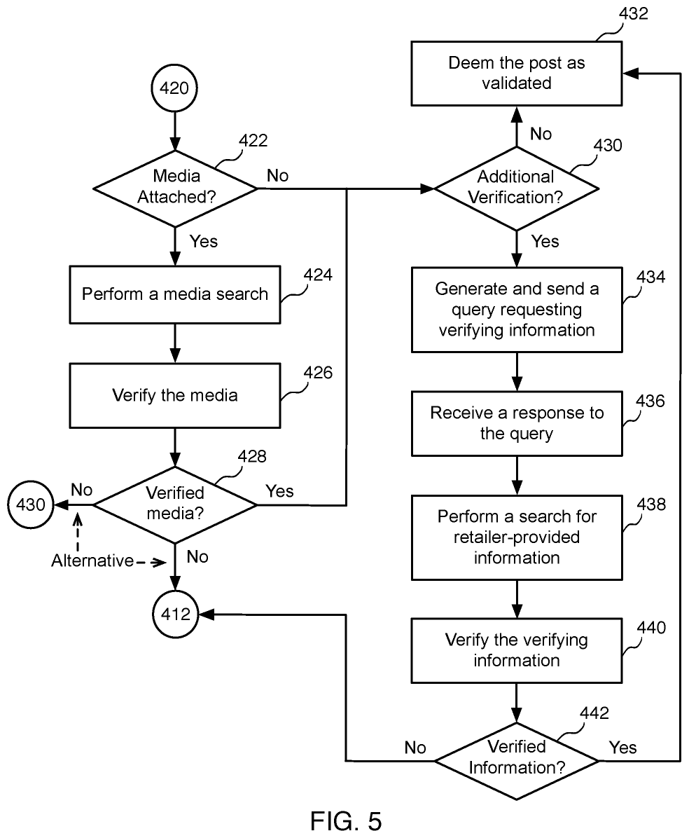

FIGS. 4 and 5 illustrate an example flow diagram for validating a social post, according to some embodiments. As described in more detail herein, the system validates social posts in the context of various scenarios. Referring to both FIGS. 1 and 4, a method begins at block 402, where a system such as server 102 analyzes the content of the post. As indicated above, in various embodiments, the system may use various techniques in text analysis, natural language processing, computational linguistics, etc., when analyzing the content of the post.

At block 404, the system determines the user who published the post. For example, the system may determine the user name or user identifier in the post.

At block 406, the system performs a customer search, searching for the user in a customer database (e.g., in database 106 of FIG. 1 or in another database accessible by the system, etc.). In various embodiments, the system performs the customer search in real-time. The system determines if the user is an actual customer of the business based on whether the user is in found in the customer database. The system searches for the social profile that matches the user. The social profile may have information such as name, email, any other identifying information, purchase history, location history, etc.

At block 408, the system verifies if the user is a customer of the business. In various embodiments, the system verifies if the user is an actual customer of the business, as there may be people who use social media to harm a particular business by fraudulently posting. For example, a person may publish a post that reports an insect in a juice product bought from a physical store in Boston (even though the person is from Russia and has never been to Boston and has never bought anything from the website). In another example, a person may make a post mentioning a bad ordering experience at a website (even though the person has not bought anything from the website). In these examples, the person is not an actual customer of the business, and did not buy anything from the business. Such behavior may be due to unhealthy competition or due to some other illegitimate or illicit reason.

At block 410, the system determines if the user is a verified customer. If no, the flow continues to block 412. If yes, the flow continues to block 414. In some embodiments, if the customer cannot be verified, the system still performs the additional verifications of other criteria, continuing to block 414. In such embodiments, the fact that the customer is not verified weighs into the final decision if a post is fraudulent or not. In such embodiments, verification of the user as a customer is not the only criteria.

In various embodiments, the system may assign a “fraud rating” to the post by considering each criteria and increasing the rating for each criteria that fails. Accordingly, if a post is rated above a certain (configurable by retailer) threshold, then it will be considered fraudulent. If the specific criteria is verified to be true, the system does not add to the rating. If the specific criteria is inconclusive, the system adds a small amount to the rating. If the specific rating is determined to be untruthful, the system adds a large amount to the rating. In various embodiments, the system applies the same fraud rating to each verification step (e.g., product verification, media verification, additional information verification, etc.).

At block 412, the system deems the post as fraudulent (not validated), if the system does not verify the user as an actual customer of the business at block 410. As indicated above, in various embodiments, if the system deems the post as fraudulent, the system disables the ability of users of the social network to virally distribute the post. For example, the system may prevent users from marking the posting with a “like” feature. The system may also prevent other users from sharing the post, etc. As a result, people who are not customers of the business are prevented from making fraudulent posts against the business.

In some embodiments, if the system searches the customer database for the user and does not find the user in the customer database, the system may immediately deem the post as fraudulent and prevent the post from being distributed by other users. In some embodiments, if the system does not find the user in the customer database, the system may validate other information in connection with other blocks in the flow diagram of FIGS. 4 and 5. For example, the system may verify additional information such as an order date, etc. at blocks 434 to 442.

At block 414, the system determines the product referred to in the post. While some embodiments are described herein in the context of products, these embodiments may also apply to services.

At block 416, the system performs a product search, searching for the product in a product database (e.g., in database 106 of FIG. 1 or in another database accessible by the system, etc.). In various embodiments, the system performs the product search in real-time. The system searches for a product that matches the product referred to in the post. The product profile may have information such as a product name and any other identifying information, inventory number, etc.

At block 418, the system verifies if the user purchased the product from the business. In various embodiments, the system determines if the post refers to a product purchased from the business. The system then verifies if the user purchased the product from the business. In other words, the user may be an actual customer of the business, but did not actually make this purchase in question.

In various embodiments, the system may look at the stored purchase history, which may be stored at the business and/or the any database accessible by the system. If no matching purchase history information is found, the system may determine that the customer has not bought the product in question (e.g., juice, etc.).

At block 420, the system determines if the product is a verified product. If no, the flow continues to block 412. If yes, the flow continues to block 422.

At block 412, the system deems the post as fraudulent (not validated), if the system does not verify that the user purchased the product from the business at block 420. As indicated above, in various embodiments, if the system does not verify that the user purchase the product from the business, the system may the system still perform the additional verifications of other criteria, continuing to block 422, and continuing to validate other information at other blocks in the flow diagram of FIG. 4.

For example, if the system does not verify the purchase, the system may immediately deem the post as fraudulent and prevent the post from going viral. Alternatively, the system may ask the user for additional information such as an order date, etc. at block 414.

Referring to FIGS. 1, 4, and 5, at block 422, the system determines if the post includes media associated with the product (e.g., if media is attached). Media may include one or more photos, one or more videos, a link to one or more photos and/or videos, one or more documents, etc. If yes, the flow continues to block 424. If no, the flow continues to block 430.

At block 424, the system performs a media search. In some scenarios, the user may be an actual customer of the business and may have bought the product from the business. However, the user may have taken the image from the Internet from a source unrelated to the business or may have modified the image using photo editing software, etc. In various embodiments, the system searches one or more databases for the photo.

At block 426, the system verifies the media based on one or more media validation criteria. In some embodiments, at least one of the media validation criteria may require that the media in the post is not a publically available image that the user took from a source unrelated to the business. As such, the system may also search the Internet for images based on the product name and other product information to find any matching images. If the system searches the Internet and finds the same photo of the product (e.g., juice with an insect, etc.) at a source unrelated to the business, the system may deem the photo as fraudulent.

In some embodiments, the system may prompt the user to confirm (e.g., provide a consent) that the photo is the correct photo. For example, the prompt may state, “Are you sure you are posting the image of the product you bought? If you say Yes, we will keep “like” and “share” options disabled for some time.” In various embodiments, if the user answers the questions (e.g., date of the order, expiration date, etc.) when prompted, the system compares the user-provided information against known order records and products sold on that date, if available, to see if the user-provided information is valid. In some embodiments, even if the user lies and still confirms that the photo is correct, the system may still publish the post but disable the post options that can make the post viral (e.g., “share,” “like,” etc.). The system may also display to the user an informative message such as, “Some of the options on the post will be disabled for the next few hours. Sorry for the inconvenience!” As indicated above, if particular information (e.g., customer, product, media, etc.) cannot be verified, the system still performs the additional verifications of other criteria. As such, the system may wait to enable such post options until after verifying other information, when the system makes the final decision if a post is fraudulent or not.

In various embodiments, the system may request a consent rather than exact information (e.g., order date, etc.) for various reasons. For example, the user, with the intention of making a fraudulent post, may stop upon receiving the consent request seeing that system is intelligent. Another reason may be to convey to the seller/retailer the second validation after the post is published without viral options. That is, the system may prompt the user for additional information/consents when the system is not able to confirm that the negative post contents are valid. In some embodiments, if the system temporarily disables the viral options such as the “share” and “like” features, the system may enable these features after a predetermined time period (e.g., 3 hours, 6 hours, etc.) elapses. In some embodiments, the system may enable these features after a retailer shares with the system results of a second validation performed by the retailer. In various embodiments, the system is sufficiently intelligent to derive which data is missing in the contents of the negative post and which data is suspected to be invalid. As such, the system may request additional data (derived the missing data). In some scenarios, the system may simply request consent.

In some embodiments, at least one of the media validation criteria may require that the media be a media associated with a product that is sold by the business. The business-provided photo may be one, for example, that the business posts on the business website or affiliate website. In various embodiments, the system may use image recognition techniques to detect and identify the product in the photo. The system may then compare the image of the photo to images of the products sold by the business. If the system does not find a match, the system may deem the photo to be fraudulent in that the product in the posted image is not a product that the business sells at block 420.

If the system finds a match, the system may deem the media to at least contain an image of a product that the business sells. In some embodiments, the system may perform further validation of the photo. For example, if a matching image is found with a product that the business indeed sells but with a flaw (e.g., with an insect in the product, etc.), the system may determine if the media item had been doctored (e.g., modified using editing software, etc.). In various embodiments, the system may employ one or more tools that examine a media item (e.g., image, etc.) and give a recommendation on whether the media is manipulated or not. For example, if an image posted matches an image that can easily be found with a web search, the system may then determine that the poster did not create the image, especially if copies of the same image substantially predate the user's post.

At block 428, the system determines if the media is verified. If no, the flow continues to block 412, where the system deems the post as fraudulent (not validated). At block 412, the system deems the post as fraudulent (not validated), if the system does not verify the media at block 412. As indicated herein, in various embodiments, if the media cannot be verified, the system may still perform additional verifications of other criteria, continuing to block 430. If the system verifies the media, the flow continues to block 430.

At block 430, the system determines if additional verification of other information in the post is needed. If no additional information needs to be verified, the flow continues to block 432. If other information needs to be verified, the flow continues to block 434. In some scenarios, the user may be a customer of the business and may have bought the product from the business. However, in this example scenario, the user makes fraudulent comments in the post such as, “Business A sold expired cookies to me.” In various embodiments, the system may analyze the post for particular key words (e.g., expired, spoiled, etc.).

At block 434, the system generates a query and sends the query to the user who created the post, where the query requests verifying information. Such verifying information may be any additional information that the system may require for validation of the post. For example, the system may prompt the user to enter an order date, with a text prompt such as, “We will need an order/shipping date in order to be able to publish your post. Please enter your order date,”). The system may also prompt the user to enter the expiration date, with a text prompt such as, “We will need the expiration date in order to be able to publish your post. Please enter the expiry date,”). In some embodiments, the system does not verify the additional information requested in a dynamically formed query in real-time. The additional information may be requested in order to support a second or final validation, which the system may perform automatically without user intervention or may be manual, where the system receives input from a person for consideration. In various embodiments, the system keeps viral options disabled until the second or final validation occurs or until a predetermined time period (e.g., 10 minutes, 30 minutes, 1 hour, 2 hours, etc.), whichever occurs first.

At block 436, the system then receives a response to the query from the user, where the response includes the verifying information (e.g., an order date, an expiration date, etc.).

At block 438, the system performs a search for retailer-provided information. The system then compares the user-provided verifying information against the business-provided information.

At block 440, the system then verifies the verifying information. In various embodiments, the system verifies if the verifying information matches retailer-provided information. In various embodiments, the system does not verify the verifying information if the system determines that the verifying information does not match the retailer-provided information. Conversely, the system verifies the verifying information if the system determines that the verifying information matches the retailer-provided information.

At block 442, the system then determines if the verifying information is verified. If verifying information cannot be verified, the flow continues to block 412. If the verifying information can be verified, the flow continues to block 432.

The verifying information is validated if the system finds business-provided information that matches or corroborates with the user-provided verifying information (e.g., matching order date, matching expiration date, etc.). Conversely, the verifying information is fraudulent if the system cannot find business-provided information that matches the user-provided verifying information. For example, the system may search the inventory details of the sold cookies and may determine that the cookies have a future expiration date (e.g., different from the date given on the post, if any date was provided). In some embodiments, the system may search for common bad reviews to corroborate the post in question. If the system can corroborate the information in the post, the system may conclude that the post is might be valid. If the system cannot corroborate the information in the post, the system may further conclude that the post is fraudulent. At block 412, the system deems the post as fraudulent (not validated), if the system does not verify any other information that needs to be verified at block 442. As indicated herein, in various embodiments, the system may assign a “fraud rating” to the post by considering each criteria and increasing the rating for each criteria that fails.

In some instances, a user with the intention to make a fraudulent post may stop seeing that system is intelligent. In other instances, even if the user does not stop posting a fraudulent post (e.g., the user enters a fake order date, fake expiration date, etc., the system may still publish the post but disable the post options that can make the post viral (e.g., “share,” “like,” etc.). The system may also display to the user an informative message such as, “Some of the options on the post will be disabled for the next few hours, we feel sorry for the inconvenience!” In some embodiments, the system may provide (e.g., send, display, etc.) any user-provided information (e.g., user name or ID, product information, media items such as images, order date, expiration date, etc.) to a person for additional (e.g., manual) verification of the post. The system may subsequently receive from the person any conclusions based on the researched/investigated the details. For example, if the person finds that the post is actually not fraudulent, the system may receive such information may determine whether to enable the “share” and “like” options at a final decision.

At block 432, the system deems the post as validated, if the system verifies any other information that needs to be verified at block 442.

Embodiments described herein provide various benefits. For example, embodiments validate and control social posts for retailers by detecting fraudulent social posts and preventing such fraudulent social posts from spreading virally. As such, embodiments help a retailer in preventing its brand and reputation from getting diluted. Moreover, embodiments help a retailer in keeping existing and prospective customers who could be negatively influenced to trust fraudulent information.

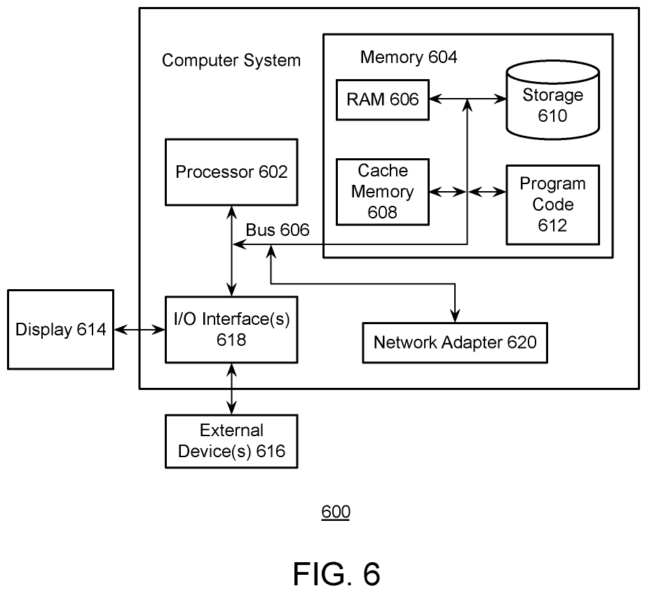

FIG. 6 is a block diagram of an example computer system 600, which may be used for embodiments described herein. For example, computer system 600 may be used to implement server device 104 of FIG. 1, as well as to perform embodiments described herein. Computer system 600 is operationally coupled to one or more processing units such as processor 602, a memory 604, and a bus 606 that couples to various system components, including processor 602 and memory 604. Bus 606 represents one or more of any of several types of bus structures, including a memory bus, a memory controller, a peripheral bus, an accelerated graphics port, a processor or local bus using any of a variety of bus architectures, etc. Memory 604 may include computer readable media in the form of volatile memory, such as a random access memory (RAM) 606, a cache memory 608, and a storage unit 610, which may include non-volatile storage media or other types of memory. Memory 604 may include at least one program product having a set of at least one program code module such as program code 612 that are configured to carry out the functions of embodiments described herein when executed by processor 602. Computer system 600 may also communicate with a display 614 or one or more other external devices 616 via input/output (I/O) interface(s) 618. Computer system 600 may also communicate with one or more networks via network adapter 620. In other implementations, computer system 600 may not have all of the components shown and/or may have other elements including other types of elements instead of, or in addition to, those shown herein.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A system comprising:
at least one processor and a computer readable storage medium having program instructions embodied therewith, the program instructions executable by the at least one processor to cause the at least one processor to perform operations comprising:
receiving, at a social network, a post created by a user;
determining that the post contains negative sentiments;
determining that the post is about a business that has subscribed to a post tracking service;
determining asserted information in the post;
searching known information that is relevant to the asserted information;
matching the asserted information against the known information;
validating the post based at least in part on the matching of the asserted information against the known information; and
disabling an ability of users of the social network to distribute the post if the post is not validated.

2. The system of claim 1, wherein, to validate the post, the at least one processor further performs operations comprising verifying if the user is a customer of the business.

3. The system of claim 1, wherein, to validate the post, the at least one processor further performs operations comprising:
determining if the post refers to a product purchased from the business; and
verifying if the user purchased the product from the business.

4. The system of claim 1, wherein, to validate the post, the at least one processor further performs operations comprising:
determining if the post refers to a product purchased from the business;
determining if the post includes media associated with the product; and
verifying the media based on one or more media validation criteria.

5. The system of claim 1, wherein, to validate the post, the at least one processor further performs operations comprising:
generating a query; and
sending the query to the user who created the post, wherein the query requests verifying information.

6. The system of claim 1, wherein, to disable the ability of users of the social network to distribute the post, the at least one processor further performs operations comprising preventing users from marking the posting with a “like” or “share” feature.

7. The system of claim 1, where the at least one processor further performs operations comprising enabling the ability of users of the social network to distribute the posting if the post is validated.

8. A computer program product comprising a computer readable storage medium having program instructions embodied therewith, the program instructions executable by at least one processor to cause the at least one processor to perform operations comprising:
receiving, at a social network, a post created by a user;
determining that the post contains negative sentiments;
determining that the post is about a business that has subscribed to a post tracking service;
determining asserted information in the post;
searching known information that is relevant to the asserted information;
matching the asserted information against the known information;
validating the post based at least in part on the matching of the asserted information against the known information;
disabling an ability of users of the social network to distribute the post if the post is not validated.

9. The computer program product of claim 8, wherein, to validate the post, the at least one processor further performs operations comprising verifying if the user is a customer of the business.

10. The computer program product of claim 8, wherein, to validate the post, the at least one processor further performs operations comprising:
determining if the post refers to a product purchased from the business; and
verifying if the user purchased the product from the business.

11. The computer program product of claim 8, wherein, to validate the post, the at least one processor further performs operations comprising:
determining if the post refers to a product purchased from the business;
determining if the post includes media associated with the product; and
verifying the media based on one or more media validation criteria.

12. The computer program product of claim 8, wherein, to validate the post, the at least one processor further performs operations comprising:
generating a query; and
sending the query to the user who created the post, wherein the query requests verifying information.

13. The computer program product of claim 8, wherein, to disable the ability of users of the social network to distribute the post, the at least one processor further performs operations comprising preventing users from marking the posting with a “like” or “share” feature.

14. The computer program product of claim 8, wherein the at least one processor further performs operations comprising enabling the ability of users of the social network to distribute the posting if the post is validated.

15. A computer-implemented method for validating and controlling social posts, the method comprising:
receiving, at a social network, a post created by a user;
determining that the post contains negative sentiments;
determining that the post is about a business that has subscribed to a post tracking service;
determining asserted information in the post;
searching known information that is relevant to the asserted information;
matching the asserted information against the known information;
validating the post based at least in part on the matching of the asserted information against the known information;
disabling an ability of users of the social network to distribute the post if the post is not validated.

16. The method of claim 15, wherein, to validate the post, the method further comprises verifying if the user is a customer of the business.

17. The method of claim 15, wherein, to validate the post, the method further comprises:
determining if the post refers to a product purchased from the business; and
verifying if the user purchased the product from the business.

18. The method of claim 15, wherein, to validate the post, the method further comprises:
determining if the post refers to a product purchased from the business;
determining if the post includes media associated with the product; and
verifying the media based on one or more media validation criteria.

19. The method of claim 15, wherein, to validate the post, the method further comprises:
generating a query; and
sending the query to the user who created the post, wherein the query requests verifying information.

20. The method of claim 15, wherein, to disable the ability of users of the social network to distribute the post, the method further comprises preventing users from marking the posting with a “like” or “share” feature.
